(19) United States
(12) Patent Application Publication
(10) Pub. No.: US 2015/0271992 A1
(43) Pub. Date: Oct. 1, 2015

(54) CORD-TYPE MOWING MACHINE

(71) Applicant: NAGOSHI CORPORATION, Shimoniikawa-gun (JP)

(72) Inventor: Masao Nagoshi, Shimoniikawa-gun (JP)

(73) Assignee: NAGOSHI CORPORATION, Shimoniikawa-gun (JP)

(21) Appl. No.: 14/601,372

(22) Filed: Jan. 21, 2015

(30) Foreign Application Priority Data
Mar. 26, 2014 (JP) 2014-063852

(51) Int. Cl. A01D 34/416

(52) U.S. Cl. CPC A01D 34/4163; A01D 34/4166

(57) ABSTRACT

The cord-type mowing machine is configured as follows: a body has a pillar; a reel is interpolated to the pillar; a ratchet wheel is interpolated to the pillar, and is stored inside the reel, and is rotated in a direction same as that of the reel; a ring is attached to the upper side of the reel; an upper cap is fixed to the upper end of the pillar; noreturn projections are successively formed on the undersurface of the upper cap; the ratchet wheel has a gathering pallet and is pressed toward the upper cap by a coil spring and the gathering pallet of the ratchet wheel is locked in a noreturn projection toward the letting-out direction of the cord; when the ratchet wheel falls due to a shock, locking between the gathering pallet and the noreturn projection is unlocked and the reel becomes rotatable in the letting out direction; the ring has an unlocking projection; when the ring is rotated in a winding direction, the gathering pallet climbs over the noreturn projection and the reel rotates in the winding direction; when the ring is rotated in the letting-out direction, the unlocking projection comes into contact with the gathering pallet; with the ratchet wheel pushed downward, the locking between the gathering pallet and the noreturn projection is unlocked and the reel becomes rotatable in the letting-out direction.

### TECHNICAL FIELD

The present invention relates to a cord-type mowing machine that mows the grass by rotating a resin cord at high speed.

### BACKGROUND ART

In a cord-type mowing machine in which a resin cord used in place of a metal blade is rotated at high speed, the cord is wound by a reel. When the cord becomes short due to wear or damage, by rotating the reel, the cord is let out to have a predetermined length. Here, as a mechanism for letting out the cord, there has been a mechanism employing a kick-out method as shown in Patent Document 1. In this mechanism, by striking the main body of a mowing machine to the ground while the mowing machine is operating, a ratchet wheel engaging with the reel rotates by one segment against the energizing force of a coil spring; as a result, the cord is let out by a predetermined length; on the other hand, the winding of the cord is performed by rotating the reel by hand. As another mechanism, there has been a mechanism employing a manual rotation method as shown in Patent Document 2. In this mechanism, while the mowing machine is stopping, the cord is let out and wound by rotating the reel by hand.

### CITATION LIST

### Patent Literature

Patent Document 1: JP H7-31249 A

Patent Document 2: JP H9-238537 A

### SUMMARY OF INVENTION

### Technical Problem

In the kick-out method of Patent Document 1, even during mowing work, a cord can be let out without stopping a mowing machine, but the cord cannot be let out by rotating a reel in a manual manner. Therefore, when the cord is entwined inside the mowing machine, the main body must be disassembled to perform adjustment. On the other hand, in the manual rotation method of Patent Document 2, a cord can be let out and wound freely in a manual manner, and adjustment is easily performed when the cord is entwined. However, in order to let out the cord during mowing work, the mowing machine must be stopped, which makes working efficiency worse.

In consideration of the above situation, an object of the present invention is to provide a cord-type mowing machine that can let out a cord in both of the kick-out method and the manual reel rotation method.

### Solution to Problem

The present invention is characterized as follows: a cord-type mowing machine comprises a body, a reel, a ratchet wheel, a ring, and an upper cap; wherein the body is approximately cylindrically shaped, with the upper side thereof opened and with a pillar provided at the center of the bottom face thereof; the reel is an object around which a cord is wound, and is approximately annulus ring shaped, and is extrapolated to the pillar, and is stored inside the body so as to be rotatable; the ratchet wheel is approximately annulus ring shaped, and is extrapolated to the pillar, and is stored inside the reel, and engages with the reel so as to be rotated in a direction same as that of the reel; the ring is attached to the upper side of the reel, and covers the upper end of the body; the upper cap is approximately disk shaped, and is fixed to the upper end of the pillar from the upper side of the ring; on the undersurface of the upper cap, noreturn projections are formed successively around the pillar; the ratchet wheel has a gathering pallet in the outer circumference part thereof, and is pressed toward the upper cap by a coil spring extrapolated to the pillar, and the gathering pallet of the ratchet wheel is locked in a noreturn projection toward the letting-out direction of the cord; when the ratchet wheel falls, due to a shock from the outside, against the energizing force of the coil spring, locking between the gathering pallet and the noreturn projection is unlocked and the reel becomes rotatable in the letting-out direction of the cord; the ring can rotate only by a predetermined angle relative to the reel, and an unlocking projection is provided at the position of the outer circumference side of the noreturn projection of the upper cap; when the ring is rotated in the winding direction, the gathering pallet of the ratchet wheel climbs over the noreturn projection against the energizing force of the coil spring, and the reel rotates in the winding direction of the cord; when the ring is rotated in the letting-out direction of the cord, the unlocking projection of the ring comes into contact with the gathering pallet of the ratchet wheel, and with the ratchet wheel pushed downward against the energizing force of the coil spring, the locking between the gathering pallet and the noreturn projection is unlocked and the reel becomes rotatable in the letting-out direction of the cord.

### ADVANTAGEOUS EFFECT OF INVENTION

According to the present invention, letting out a cord can be performed in both of the kick-out method and the manual reel rotation method. That is, by striking the main body to the ground while operating the mowing machine, the reel becomes rotatable in the letting-out direction of the cord. Since the cord is let out by a centrifugal force, there is no need to stop mowing work. With the ring rotated in the winding direction, the reel is rotated and the cord can be wound in a manual manner; furthermore, with the ring rotated in the letting-out direction, the reel becomes rotatable in the letting-out direction of the cord; with the cord pulled by hand, the reel is rotated and the cord can be let out; thus, adjustment can be easily performed when the cord is entwined.

### BRIEF DESCRIPTION OF DRAWINGS

FIG. 1(a) is a perspective view of the main body of a mowing machine (a state where an upper cap is removed), and FIG. 1(b) is an enlarged view of the top surface part of FIG. 1(a).

FIG. 2 is a perspective view of the main body of the mowing machine (a state where the upper cap is attached).

FIG. 3 is a plan view of the main body.

FIG. 4 is a side view of the main body.

FIG. 5(a) is a cross sectional view depicted if cutting is performed along the line V-V in FIG. 3, and FIG. 5(b) is a view depicted if a component extrapolated to a pillar in FIG. 5(a) is not cut.

FIG. 6 is an exploded perspective view of the main body.

FIGS. 7(a) to 7(c) are cross sectional views depicted if cutting is performed along the line VII-VII in FIG. 3, and describe how letting-out is performed by a kick-out method.

FIG. 8 is a cross sectional view depicted if cutting is performed along the line VIII-VIII in FIG. 3, and describes how winding is performed by a manual rotation method.

FIGS. 9(a) and 9(b) are cross sectional views depicted if cutting is performed along the line VIII-VIII in FIG. 3, and describe how letting-out is performed in the manual rotation method.

### DESCRIPTION OF EMBODIMENT

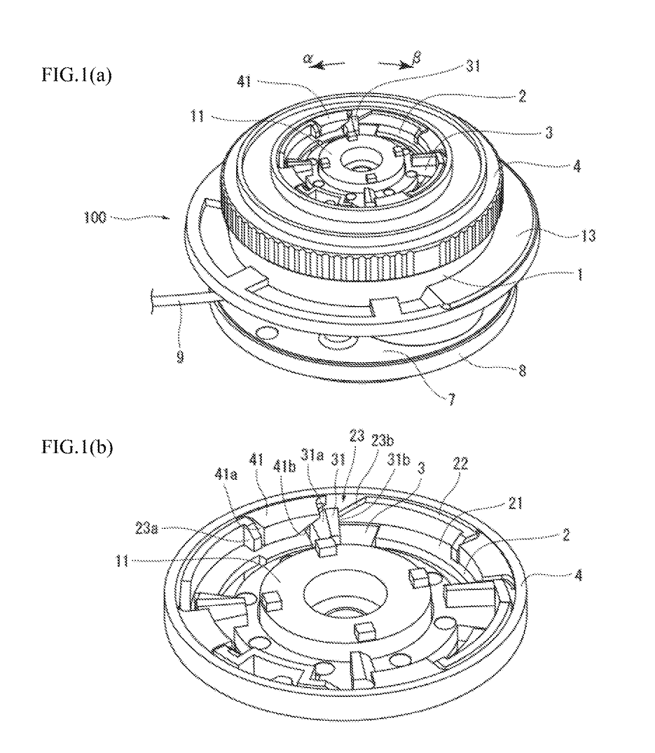

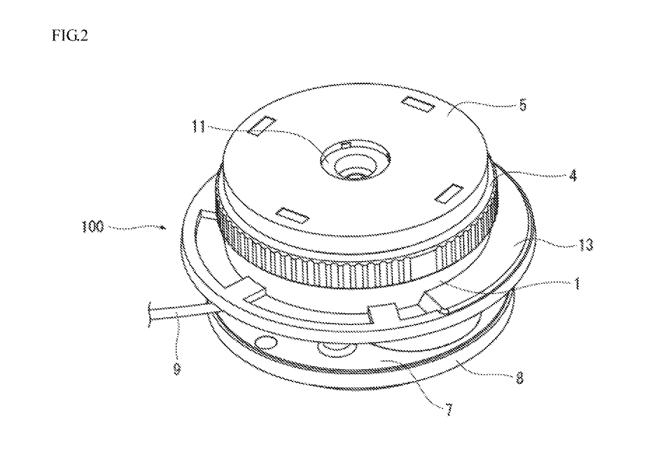

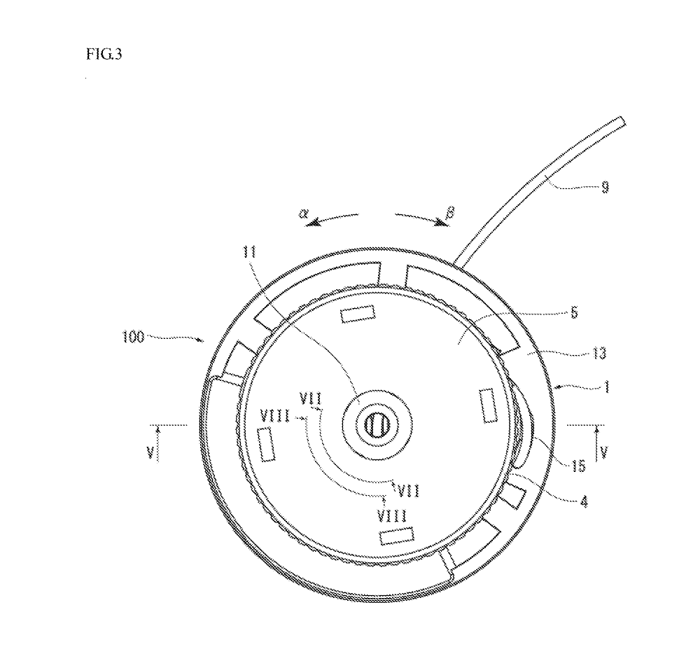

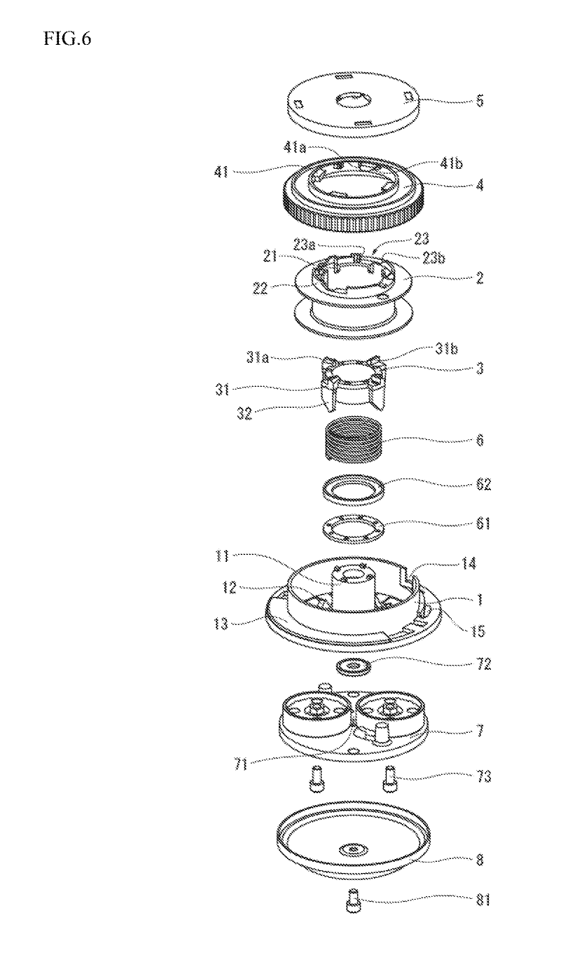

The specific configuration of the cord-type mowing machine of the present invention will be described based on each of the drawings. This cord-type mowing machine is structured such that a main body 100 is attached to the leading end of a shaft 200, as shown in FIG. 4. The main body 100 comprises a body 1, a reel 2, a ratchet wheel 3, a ring 4, an upper cap 5, a guide board 7 and a lower cap 8, as shown in FIGS. 1 to 6.

The body 1 is approximately cylindrically shaped with the upper side thereof opened, and with a flange 13 formed in the outer circumference side of the lower end thereof, and with an approximately columnar shaped pillar 11 provided at the center of the bottom face thereof; around the pillar 11 of the bottom face of the body 1, chevron projections 12 with an approximately isosceles triangle shape are successively formed at intervals on a circumference separated from the pillar 11 with a certain gap. The guide board 7 is approximately disk shaped with two approximately columnar shaped parts formed on the top surface thereof. A gap between the two approximately columnar shaped parts serves as an eyelet 71 from which the leading end of a cord 9 is pulled out. The guide board 7 is fixed to the undersurface of the body 1 via a washer 72 with two bolts 73. The lower cap 8 made of metal is approximately bowl shaped, and is fixed to the undersurface of the guide board 7 with one bolt 81. It is noted that on the side face of the body 1, there is formed an outlet 14 through which the cord 9 is passed. On the flange 13 and near the outlet 14, there is formed a through-hole 15 which penetrates through the flange 13 in the vertical direction.

The reel 2 is an object to which the base end of a cord 9 is fixed and around which the cord is wound, and is approximately annulus ring shaped. On the upper end and the lower end of the reel 2, there are respectively provided flanges which project toward the outer circumference side. The cord 9 has been wound clockwise; when the reel 2 is rotated counterclockwise, the cord 9 is wound; when the reel 2 is rotated clockwise, the cord 9 is let out (hereinafter, the counterclockwise direction is called as a winding direction α, and the clockwise direction is called as a letting-out direction β). On the upper end of the inner circumferential side face of the reel 2, there are respectively provided engaging projections 21 at four places. Furthermore, on the inner circumferential side edge of the top surface, a vertically arranged wall face 22 is provided on the circumference. On this vertically arranged wall face 22, there are respectively provided notches 23 at four places. The notch 23 has a vertical face 23a on the side of the winding direction α and an inclined face 23b on the side of the letting-out direction β, and the inclined face 23b of each notch 23 is located at the middle of the engaging projections 21 that adjoin each other. The reel 2 configured in this way is extrapolated to the pillar 11 and is stored inside the body 1 so as to be rotatable. The leading end of the cord 9 wound around the reel 2 is pulled out from the outlet 14, and passes though the through-hole 15; then the leading edge of the cord 9 goes around under the body 1 and passes through the eyelet 71, projecting toward outer circumference side from the main body 100.

The ratchet wheel 3 is approximately annulus ring shaped, and on the outer circumference part of the upper end thereof, there are provided four gathering pallets 31. The gathering pallet 31 has an inclined face 31a on the side of the winding direction α of the upper side thereof and has a vertical face 31b on the side of the letting-out direction β. Moreover, the gathering pallets 31 has a drooping piece 32 on the lower side thereof, and the lower end of the drooping piece 32 inclines on both sides of the winding direction α and the letting-out direction β, having a pointed shape. The ratchet wheel 3 configured in this way is extrapolated to the pillar 11 and is stored inside the reel 2. At this time, a bearing 61, a washer-shaped spring receptacle 62 and a coil spring 6 are extrapolated to the pillar 11 in order from the bottom. All of these are stored between the pillar 11 and the chevron projection 12. With the ratchet wheel 3 extrapolated from the above, the coil spring 6 is stored inside the drooping piece 32 of the gathering pallet 31, and the lower end of the gathering pallet 31 is opposed to the chevron projection 12. The engaging projection 21 provided on the inner circumferential side face of the reel 2 fits in between the gathering pallets 31, of the ratchet wheel 3, which adjoin each other. Therefore, the ratchet wheel 3 engages with the reel 2 so as to rotate in the same direction as that of the reel 2 (since there exists a clearance between the gathering pallet 31 and the engaging projection 21, the mutual rotation of about 10 degrees occurs) , and becomes movable in the vertical direction. Since the coil spring 6 is supported by the bearing 61, the ratchet wheel 3 and the reel 2 are freely rotatable inside the body 1 and the ratchet wheel 3 is energized upward.

The ring 4 is approximately annulus ring shaped and is attached to the upper side of the reel 2. The vertically arranged wall face 22 of the reel 2 is stored in the inner circumference side of the ring 4. It is shaped such that the ring 4 covers the upper end of the body. On the outer circumferential side face of the ring 4, there is formed unevenness, making it easy to rotate the ring by hand. On the upper end of the inner circumferential side face of the ring 4, there are respectively provided unlocking projections 41 at four places. The unlocking projection 41 is an object which fits in the notch 23 of the vertically arranged wall face 22 of the reel 2, and has a vertical face 41a on the side of the winding direction α and an inclined face 41b on the side of the letting-out direction β, corresponding to the shape of the notch 23. Since the length of the unlocking projection 41 is shorter than that of the notch 23 in the circumferential direction, there is formed a gap. Therefore, the ring 4 is rotatable relative to the reel 2 only by an angle (a predetermined angle) corresponding to this gap.

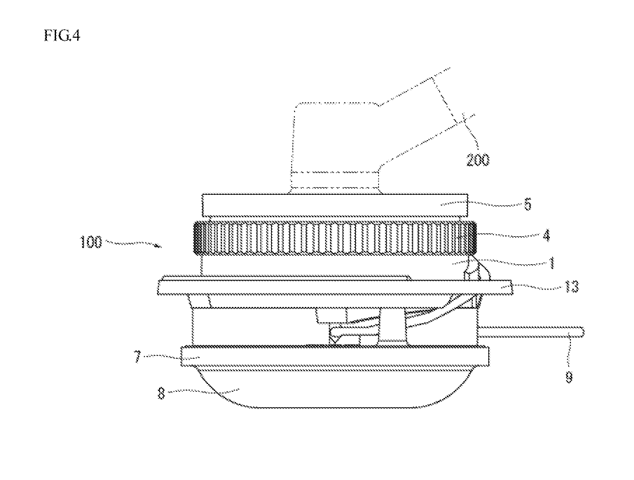

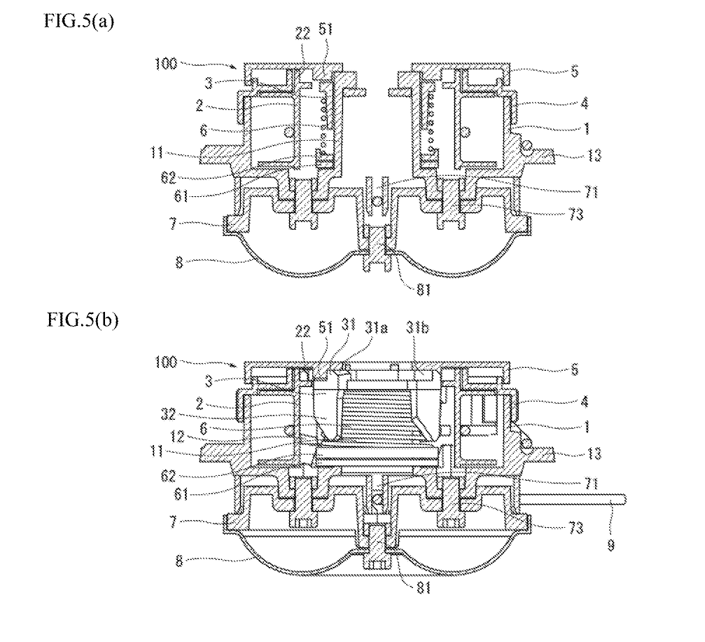

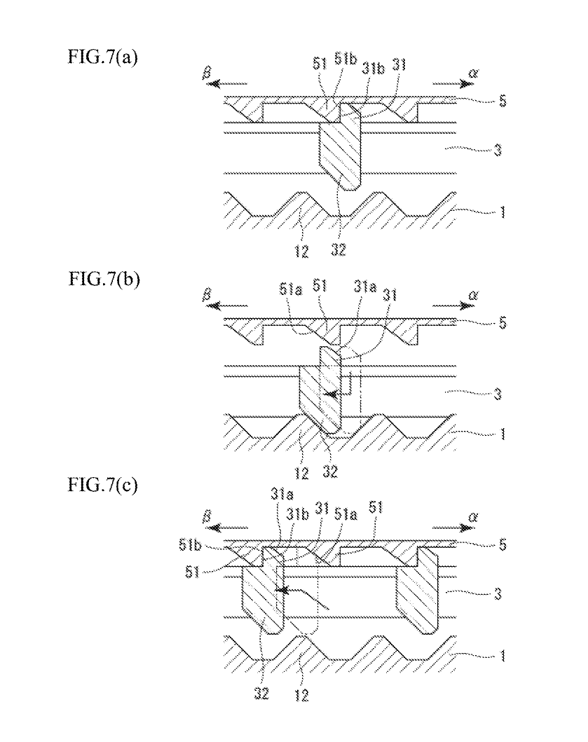

The upper cap 5 is approximately disk shaped, and is fixed to the upper end of the pillar 11 from the upper side of the ring 4, being united with the body 1. As shown in FIGS. 5 and 7, on the undersurface of the upper cap 5, noreturn projections 51 with an approximately right triangle shape are successively formed at intervals on a circumference, with being opposite to the chevron projections 12. However, the noreturn projection 51 is provided at a position shifted to an inner circumference side relative to the chevron projection 12, and the unlocking projection 41 of the ring 4 is located at the outer circumference side of the noreturn projection 51. The noreturn projection 51 has an inclined face 51a on the side of the letting-out direction β and a vertical face 51b on the side of the winding direction α. Moreover, there are provided the noreturn projections 51, the number of which is same as that of the chevron projections 12, and the vertical face 51b of the noreturn projection 51 is located right above the mid-position of the chevron projections 12 that adjoin each other. Against the upper cap 5 configured in this way, the ratchet wheel 3 is pressed by the coil spring 6. Thereby, the upper end of the gathering pallet 31 of the ratchet wheel 3 is opposed to both of the unlocking projection 41 of the ring 4 and the noreturn projection 51 of the upper cap 5.

Next, descriptions will be made on the letting-out and the winding of the cord 9 in the mowing machine configured in this way. Although the reel 2 needs to be rotated in order to let out and wind the cord 9, the reel 2 is interlocked with the ratchet wheel 3 in the direction of rotation; the rotation of the ratchet wheel 3 is controlled with the gathering pallet 31 engaging and disengaging with the noreturn projection 51 of the upper cap 5, the chevron projection 12 of the body 1 and the unlocking projection 41 of the ring 4. Therefore, a relationship between the ratchet wheel 3 and each projection will be shown in each of the above cases.

First, a description will be made on a case where the cord 9 is let out by a kick-out method. Normally, the ratchet wheel 3 is pressed against the upper cap 5 by the energizing force 6 of the coil spring 6; as shown in FIG. 7(a), the vertical face 31b of the gathering pallet 31 of the ratchet wheel 3 comes into contact with the vertical face 51b of the noreturn projection 51, and the gathering pallet 31 is locked in the noreturn projection 51 toward the letting-out direction β. The lower end of the drooping piece 32 of the gathering pallet 31 is opposed to a valley between the chevron projections 12 that adjoin each other. In this state, since the ratchet wheel 3 and the reel 2 cannot rotate in the letting-out direction β, the cord 9 is not let out freely even if the main body 100 is rotated at high speed for mowing work. When the cord 9 becomes short due to wear and damage, the lower cap 8 of the main body 100 is struck to the ground while the mowing machine is being operated. Then, due to that shock, the ratchet wheel 3 falls against the energizing force of the coil spring 6. Thereby, as shown in FIG. 7 (b), the locking between the gathering pallet 31 and the noreturn projection 51 is unlocked, and the lower end of the drooping piece 32 of the gathering pallet 31 falls in the valley between the chevron projections 12 that adjoin each other. At this time, since the main body 100 is rotating and a centrifugal force is acting on the cord 9, the reel 2 and the ratchet wheel 3 rotate in the letting-out direction β by the pulling action of the cord 9. With rotation, the ratchet wheel 3 rises due to the energizing force of the coil spring 6; as shown in FIG. 7(c), the inclined face 31a of the upper end of the gathering pallet 31 slides on the inclined face 51a of the noreturn projection 51, and further rotates in the letting-out direction β; the vertical face 31b of the gathering pallet 31 is locked in the vertical face 51b of a next noreturn projection 51 that adjoins in the letting-out direction β. In this way, the reel 2 and the ratchet wheel 3 rotate in the letting-out direction β by one segment of the nonreturn projection 51, and the cord 9 is let out by a predetermined length.

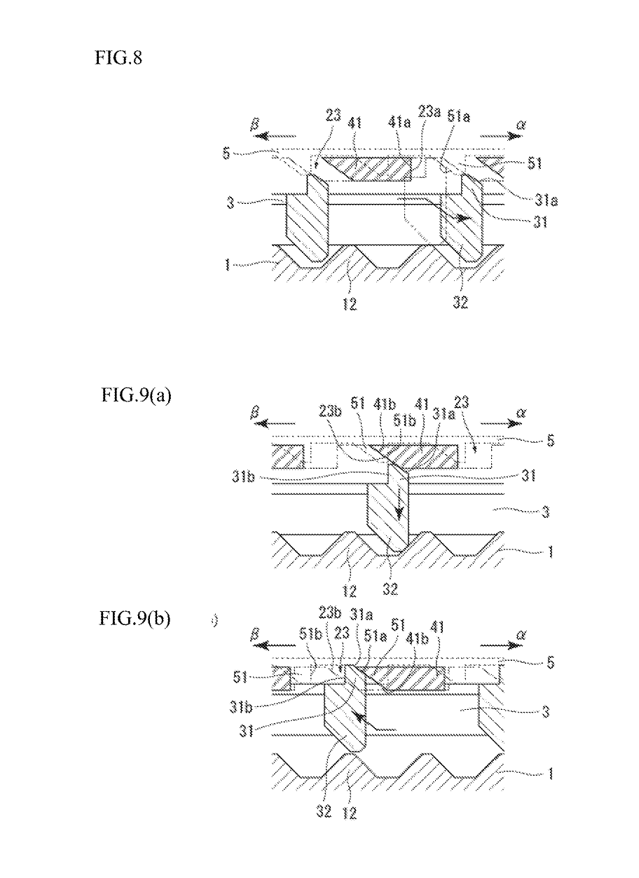

Next, a description will be made on a case where the cord 9 is wound. In this case, when the ring 4 is rotated by hand in the winding direction α, as shown in FIG. 8, the vertical face 41a of the unlocking projection 41 of the ring 4 comes into contact with the vertical face 23a of the notch 23 of the reel 2 (the dashed dotted line); the ring 4 and the reel 2 rotates in a united manner, and furthermore the ratchet wheel 3 also rotates in the same direction (the winding direction α) as that of the reel 2. Then, the inclined face 31a of the upper end of the gathering pallet 31 of the ratchet wheel 3 slides on the inclined face 51a of the noreturn projection 51 of the upper cap 5 (the dashed line), and the ratchet wheel 3 is pushed down against the energizing force of the coil spring 6. As a result, the gathering pallet 31 climbs over the noreturn projection 51. When the ratchet wheel 3 is pushed down, since the lower end of the drooping piece 32 of the gathering pallet 31 falls in the valley between the chevron projections 12 that adjoin each other, the chevron projecton 12 does not prevent rotation. Therefore, the ring 4, the reel 2 and the ratchet wheel 3 can rotate freely in the winding direction α, and the cord 9 is wound by a length that corresponds to the rotation angle of the ring 4.

Next, a description will be made on a case where the cord 9 is let out by a manual rotation method. In this case, while the mowing machine is stopping, if the ring 4 is rotated by hand in the letting-out direction β, as shown in FIG. 9(a), the inclined face 41b of the unlocking projection 41 of the ring 4 comes into contact with the inclined face 31a of the upper end of the gathering pallet 31 of the ratchet wheel 3, and pushes down the ratchet wheel 3 against the energizing force of the coil spring 6, and the inclined face 41b comes into contact with the inclined face 23b of the notch 23 of the reel 2. The state of the ratchet wheel 3 is same as a state at the moment when the ratchet wheel 3 falls due to the damage caused with the main body 100 being struck on the ground; the locking between the gathering pallet 31 and the noreturn projection 51 is unlocked; the lower end of the drooping piece 32 of the gathering pallet 31 falls in the valley between the chevron projections 12 that adjoin each other. In this state, when the end of the cord 9 is held and pulled, the reel 2 and the ratchet wheel 3 rotates in the letting-out direction β. With rotation, the ratchet wheel 3 rises due to the energizing force of the coil spring 6, as shown in FIG. 9(b), the inclined face 31a of the upper end of the gathering pallet 31 slides on the inclined face 51a of the noreturn projection 51, and further rotates in the letting-out direction β; the vertical face 31b of the gathering pallet 31 is locked in the vertical face 51b of a next noreturn projection 51 that adjoins in the letting-out direction β. At this time, the inclined face 31a of the upper end of the gathering pallet 31 of the ratchet wheel 3 pushes the inclined face 41b of the unlocking projection 41 of the ring 4, and the ring 4 is pushed back relative to the reel 2 in the winding direction α. In this way, the reel 2 and the ratchet wheel 3 rotate in the letting-out direction β by one segment of the nonreturn projection 51, and the cord 9 is let out by a predetermined length. When the cord 9 needs to be let out further, there is repeated an operation where the cord 9 is pulled after the ring 4 is rotated in the letting-out direction β. Since the ring 4 is smaller than the flange 13 of the body 1 in diameter, there is little possibility that the ring 4 is hit against a wall etc. during mowing work; moreover, while the main body 100 is operating, since the ratchet wheel 3 is not easily moved due to the centrifugal force acting on the cord 9, the ring 4 is prevented from rotating unintentionally in the letting-out direction β, and thus the cord 9 is not let out.

In this way, according to the mowing machine of the present invention, the cord can be let out in both of the kick-out method and the manual reel rotation method. According to the kick-out method, since the cord can be let out without interrupting mowing work, good working efficiency is obtained. According to the manual rotation method, the cord can be let out and wound freely in a manual manner, and when the cord is entwined, there is no need to disassemble the main body, enabling easy adjustment.

The present invention is not limited to the above embodiment. With respect to matters relating to the letting-out and the winding of the cord, if there exist modifications that satisfy necessary requirements and achieve similar working effects, the shape of and the structure of each part can be modified, and with respect to other matters, there may be omission partly, or another function may be added.

### REFERENCE SIGN LIST

1 Body
2 Reel
3 Ratchet wheel
4 Ring
5 Upper cap
6 Coil spring
9 Cord
11 Pillar
31 Gathering pallet
41 Unlocking projection
51 Noreturn projection

1. A cord-type mowing machine comprising:
a body;
a reel;
a ratchet wheel;
a ring; and
an upper cap, wherein
the body is approximately cylindrically shaped, with an upper side thereof opened and with a pillar provided at a center of a bottom face thereof,
the reel is an object around which a cord is wound, and is approximately annulus ring shaped, and is extrapolated to the pillar, and is stored inside the body so as to be rotatable,
the ratchet wheel is approximately annulus ring shaped, and is extrapolated to the pillar, and is stored inside the reel, and engages with the reel so as to be rotated in a direction same as that of the reel,
the ring is attached to an upper side of the reel, and covers an upper end of the body,
the upper cap is approximately disk shaped, and is fixed to an upper end of the pillar from an upper side of the ring,
on an undersurface of the upper cap, noreturn projections are formed successively around the pillar,
the ratchet wheel has a gathering pallet in an outer circumference part thereof, and is pressed toward the upper cap by a coil spring extrapolated to the pillar, and the gathering pallet of the ratchet wheel is locked in a noreturn projection toward a letting-out direction of the cord,
when the ratchet wheel falls, due to a shock from the outside, against an energizing force of the coil spring, locking between the gathering pallet and the noreturn projection is unlocked and the reel becomes rotatable in the letting-out direction of the cord,
the ring can rotate only by a predetermined angle relative to the reel, and an unlocking projection is provided at a position of an outer circumference side of the noreturn projection of the upper cap,
when the ring is rotated in a winding direction, the gathering pallet of the ratchet wheel climbs over the noreturn projection against the energizing force of the coil spring, and the reel rotates in the winding direction of the cord,
when the ring is rotated in the letting-out direction of the cord, the unlocking projection of the ring comes into contact with the gathering pallet of the ratchet wheel, and with the ratchet wheel pushed downward against the energizing force of the coil spring, the locking between the gathering pallet and the noreturn projection is unlocked and the reel becomes rotatable in the letting-out direction of the cord.
